(19) United States
(12) Patent Application Publication
(10) Pub. No.: US 2006/0224454 A1
(43) Pub. Date: Oct. 5, 2006

(54) Tracking merchant specific reward credits and balances in a multi merchant environment utilizing one card or account number

(75) Inventors: Joel R. Kantor, San Diego, CA (US); Larry Kantor, San Diego, CA (US)

Correspondence Address: THELEN REID & PRIEST, LLP, P. O. BOX 640640, SAN JOSE, CA, 95164-0640, US

(73) Assignee: Synergy World, Inc.

(21) Appl. No.: 11/395,885

(22) Filed: Mar. 31, 2006

Related U.S. Application Data
(60) Provisional application No. 60/667,734, filed on Mar. 31, 2005.

(51) Int. Cl. G06Q 30/00

(52) U.S. Cl. 705/14

(57) ABSTRACT

A loyalty program system and method includes of membership card that is distributed to customers. The membership card is associated with multiple merchants whose accounts are centrally managed but segregated from one another. In this manner a customer only needs to carry a single card while participating in promotions that are controlled and managed by separate merchants. A merchant can reward customers based on the nature of the transactions with the merchants, for example based on value, frequency and so forth. In addition, it is possible to add merchants to the loyalty program even if they already have their own pre-existing customer membership base that carries pre-existing membership cards. In that case, the automated loyalty program is configured to recognize and honor the pre-existing cards by establishing in the system account files for the added merchants, and configuring the system to recognize and honor identification information provided in the pre-existing membership cards. It is also possible to use the system to track multi-balance gift certificates. It is also possible to use the system in a business-to-business barter system, in which multiple merchants are associated with one card provided to a first merchant. The first merchant can redeem the card any of one or more other merchants with which an exchange has been made, either directly or by way of a barter broker.

### CROSS-REFERENCE TO RELATED APPLICATIONS

(Not applicable)

### BACKGROUND OF THE INVENTION

1. Field of the Invention

The invention relates to methods of doing business, and more particularly, to methods of conducting loyalty marketing.

2. Description of the Related Art

Loyalty marketing is a vital and key strategy for companies trying to grow their business in a competitive marketplace. Customer loyalty has been stated by CEOs as their number one management challenge. It is well known that it costs more to acquire a new customer than to retain an existing one. A two percent increase in customer retention can earn the same profits as a ten percent reduction in operating costs. In addition, 20% of a merchant's customers can account for 80% of a merchant's revenues, making it vital to implement a customer reward/retention program. The objections if loyalty programs generally include:
1. Acquiring new customers
2. Increasing frequency of visits
3. Motivating customers to increase their average spend
4. Increasing Customer Retention by developing customer appreciation and relationships
5. Customer advocacy

There are generally six types of common loyalty programs. The first of these is a point-based rewards redeemed fro prizes at individual merchants. Such point-based reward programs are designed for the individual merchant. These programs reward customers for their patronage, frequency of visits and level of spending by offering a point-based reward system. Customers receive points for dollars spent. The merchant determines the prizes/reward to give away when the customer reaches certain point thresholds. When the reward is redeemed at the merchant, the merchant deducts points from the customer's account. The points and prizes are merchant-specific. In card-based implementations, this program is in the form of one card that is useable at one merchant. An example of a point rewarding schedule under this system is:
100 points, the customer receives a free T-shirt,
300 points, the customer receives a free dinner.
500 points, the customer receives two free diners.

A second type of common loyalty programs is point-based rewards redeemed for cash back at individual merchants. This program is very similar to the first type above, in which the customer earns and accumulates points for dollars spent. However, in this case, when the customer reaches a pre-determined point threshold, points are redeemed for cash back or a gift certificate that can be used at that merchant only. In this program, a single card is used at a single merchant. The following is an example:
100 points, the customer receives a $20 gift card or
100 points, the customer receives a $20 gift certificate or
100 points, the customer receives a $20 credit back onto their loyalty card. (Limited to one card to be used only at one merchant)

A third type of program is a multi-merchant point-based reward program. This type is typically a global point program similar to a frequent flyer program. Consumers receive points for dollars spent at participating merchants, which are usually more than one in number. A participating customer in this program redeems his/her points from a global point redemption site, for example a website. Importantly, points are not tracked and redeemed per individual merchant. The following provides an example:
1000 points they receive a free coffee maker or
5000 points they earn a free stereo.

A fourth type of program is a multi-merchant cash back reward program. This type of program is usually implemented by large credit card companies, although it may also be implemented by private label debit card companies as well. When a participating cardholder uses a major credit card brand or a private label debit card in this program, the cardholder earns, instead of points, cash back on every transaction. This cash back can be returned to the customer any of the following ways:
a.) “Credited” back to the customer credit card, for example a la The Rewards Network™
b.) Donated to a fundraising organization—for example, E-Scrip and Fundraiser Rewards™
c.) Designated towards a savings or retirement account—for example, Upromise™
d.) Added back onto the private label Debit Card—for example, Creditz™

A fifth type of common loyalty program is a multi-merchant instant rewards and voucher program. This type of program is designed to give the customer immediate rewards, incentives and targeted vouchers printed at the checkout, and is not a conventional reward points program. Many grocery stores chains have immediate coupons/vouchers that print at the point of sale and considered an example of this type of program.

A sixth type of common loyalty program is a show-and-save type program. Consumers in this case receive a plain wallet-sized card, typically of plastic or cardboard, often referred to as a discount card. It has no magnetic strip or other form of electronic information storage. The cardholder simply shows the card to the merchant, and receives a discount in return.

### BRIEF SUMMARY OF THE INVENTION

In accordance with an aspect of the invention, there is disclosed a method of conducting business. The method includes providing at least one customer with a portable device having machine-readable identification information, establishing a plurality of accounts each corresponding to a merchant and associating the machine readable information with the plurality of accounts, for at least one transaction with at least one of the plurality of merchants, determining whether the identification information is presented, and, if in association with the transaction the identification information is presented, manipulating the account corresponding to the merchant in accordance with the transaction.

In accordance with a further aspect of the invention, there is disclosed a method for distributing to each of one or more customers a portable device having a machine-readable information storage medium for storage of information therein, the information identifying a plurality of accounts associated with the one or more customers, each account corresponding to a different merchant.

In accordance with a further aspect of the invention, there is disclosed a method including authorizing a first loyalty program award by a first merchant based on information stored in a machine-readable information storage medium of a portable device, authorizing a second loyalty program award by a second merchant based on said information, adjusting a first account identifiable by said information to account for said first loyalty program award, and adjusting a second account identifiable by said information to account for said second loyalty program award.

In accordance with a further aspect of the invention, there is disclosed a method for linking first and second loyalty programs. The method includes configuring a point-of-sale device associated with the second loyalty program to recognize information stored on a portable device associated with the first loyalty program, and providing a loyalty award based on said recognized information.

In accordance with a further aspect of the invention, there is disclosed a method including writing into a portable device having a machine-readable information storage medium information reflecting an account balance associated with a first merchant, and writing into the portable device information reflecting an account balance associated with a second merchant.

In accordance with a further aspect of the invention, there is disclosed a method of administering a barter system. The method includes associating machine-readable identification information contained in a portable device with a plurality of merchants, establishing a file corresponding to said identification information, the file being associated with a plurality of accounts each corresponding to one of the plurality of merchants, and assigning a balance to each account.

In accordance with a further aspect of the invention, there is disclosed a method of administering a gift certificate program, the method including associating machine-readable identification information contained in portable device with a plurality of merchants, establishing a file corresponding to the identification information, the file being associated with a plurality of accounts each corresponding to one of the plurality of merchants, and assigning a balance to each account.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is a schematic diagram illustrating a loyalty program system; and

FIG. 2 is a schematic diagram illustrating a conceptual organization of accounts for loyalty programs, gift certificates, or barter programs.

### DETAILED DESCRIPTION OF THE INVENTION

Embodiments of the present invention are described herein in the context of a system and method for tracking merchant specific rewards and balances in a multi-merchant environment with one card or one account number. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

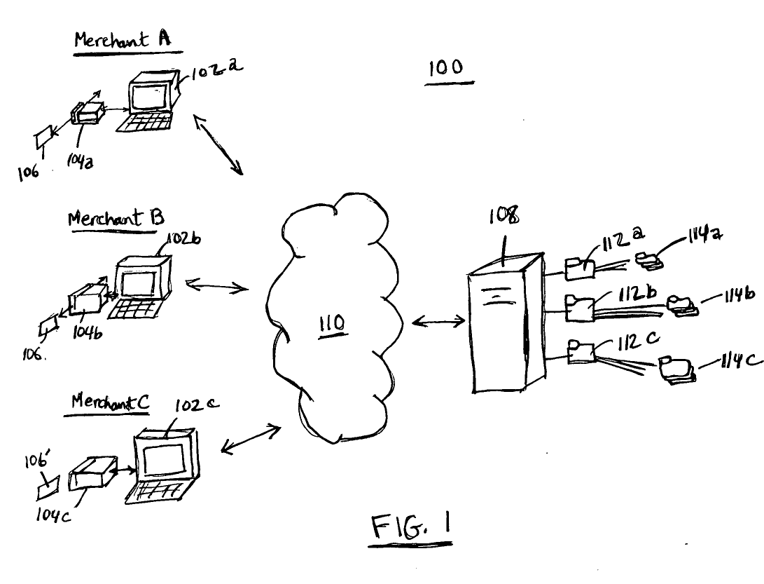

FIG. 1 is a schematic diagram of an embodiment of a system 100 for tracking merchant-specific rewards and balances in a multi-merchant environment utilizing one card or one account number. In system 100, three merchants (the number three is illustrative only) are each provided with a processing terminal 102a, 102b, 102c (referred to collectively as 102) at their point of interaction with customers. The merchants may be separate enterprises that provide different services or merchandize and are not necessarily affiliated with each other, other than being part of the system 100 as described herein. Further, although each merchant is shown as being provided with a single processing terminal 102, it will appreciated that multiple such terminals can be associated with each merchant, the multiple terminals being connected to and in communication with one another by way of a local area network (LAN), wired or wireless, in a known fashion.

The processing terminals 102 can be separate personal computers (PCs), laptops, handheld devices, PDAs, etc., or they can be cash register type devices equipped with the necessary processing capabilities as detailed further below. Each merchant location is further provided with a information reading type device, designated 104a, 104b and 104c and referred to collectively as readers 104. The reader 104 is an automated information reader configured to interact with and read information from a customer-held storage medium, for example participant cards 106 held by customers patronizing the merchant. A typical type of such interaction is a swiping motion of a magnetic strip-bearing card 106 through the reader. Magnetic heads in the reader read (and possibly write) magnetically-stored information in the magnetic card. Information is stored in machine-readable format. Other types of information storage are well-know, and may or may not be disposed on a card-type medium. They include electronic information stored on semiconductor chips (smart cards), RFID (radio frequency identification) type storage, optical (for example, bar code) storage, and so forth. IVR (interactive voice response) can also be used, wherein information is entered over a telephone terminal using a touch-tone keypad, or by speaking into the telephone, and so on. A more generic designation of the reader 104 is a point-of-sale device, although the term “sale” is not intended to mean that an actual sale is necessary, as other transactions are contemplated to be within the loyalty program.

The readers 104 are in communication with terminals 102, either wirelessly or by way of cables (not shown), and convey the information stored on the customer held storage media (participant cards 106) to the terminals. In turn, each of the processing terminals 102 is in communication with a central server system 108 by way of any known network, for example the Internet, and/or telephone lines shown generally at 110. Intermediate networks or subnets (not shown) may be present between the terminals 102 and central server system 108. Further, while central server system 108 is depicted as a single device, it will be recognized that it may comprise multiple devices having different or redundant functions. For example, gateways, routers, proxy servers, server farms and data storage devices may all be part of the central server system and configured to provide the functionality detailed further below. Of course it will be appreciated that the use of intermediate terminals 102 is optional. In an alternative aspect, readers 104 communicate directly with central server system 108 by way of network 110, without the need for processing terminals 102. Such readers would have their own communication module in the form of a wired or wireless modem, and so forth as necessary to conduct the communication with central server system 108.

Central sever system 108 contains files 112a, 112b, 112c (collectively 112) each associated with a specific merchant. Alternative to or supplementing this merchant-based association, it is contemplated that files (not shown) associated with individual customers can be similarly stored and manipulated as described below.

In accordance with one embodiment, central server system 108 is configured to track transactions between customers and merchants and to reward customers based on factors such as transaction frequency and transaction size. Merchants provided with the processing terminals 102 and readers 104 agree to be part of a merchant consortium that is served and managed by server system 108. The terminals and/or central server 108 also conduct transaction authorization. The consortium honors transactions by customers who are part of a rewards program designed to reward their behavior with regard to the consortium merchants. The customers who participate in this program, hereinafter referred to as participating customers or program customers, are each provided with one card or the like that contains identification information pertaining to the particular customer.

When a transaction pursuant to the rewards program is conducted, the identification information is read from the card 106 by the reader 104 and provided to the processing terminal 102 (or directly to server system 108). When a loyalty program award is authorized, the transaction information associated with the customer identification information is forwarded to central server system 108 for recording therein and manipulation thereby, preferably in the merchant-specific file 112. The session information, which may also be recorded in card or similar medium 106, may also include transaction particulars, such as time and date of transaction, value of transaction, location of transaction, merchant personnel associated with the transaction, processing terminal identification information, transaction-associated discounts such as coupons, and so forth.

Pursuant to the rewards program, each transaction is awarded a value that is set by the particular merchant involved. This is preferably conducted by central server system 108. Merchant A may assign a point system to the transactions, such that for each dollar spent by a customer, the merchant awards that customer an equal number of points, or alternatively some fraction or multiple thereof. Points are accumulated for redemption by the customer when certain merchant-determined thresholds are reached. Redemption can be in any form, such as cash back to the customer, a discount for the customer in subsequent transactions, gift certificates, store credit, or complimentary merchandise or services, or any combination of these. It may be that a store credit (reward credit) is earned and is added back onto the card and tracked for each merchant. Typically, once a customer is provided with credit, the value of that credit is deducted from the customer's account as said account is maintained in central server system 108. As an example, a customer who, over the course of several months and multiple visits to one or more stores operated Merchant A, has purchased $100-worth of merchandise from Merchant A, may have accumulated 100 points (at $1=1 points). As one of Merchant A's criteria, a threshold of 100 points entitles the customer to a $7.50 store credit on the customer's next purchase. Therefore, if the customer decides at the next purchase to redeem this store credit, the 100 points are deducted from the customer's account, leaving the customer with zero points. Another example is another merchant offering a $5.0 reward credit when 50 points are reached. These are separated out and tracked on one card. Subsequently, Merchant A may decide to implement a special promotion in which program participants receive 4 credit points for each dollar spent. Another example is a special promotional period (for example, the month of May), in which the value of each dollar spent by a participating customer can be raised from $1=1 points to $1=4 credit points, to encourage patronage during that period.

Merchant B may do the same thing as Merchant A, but, in addition, provide a second tier of awards, for example corresponding to the number of purchases made by the customer. The proportion of points awarded per dollar spent can be the same or different from Merchant A's $1=3 points, and there is no nexus between awards provided by Merchant B to its customers and those provided by Merchant A to its customers. Hence the points, or more generally, the credits awarded by merchants to customers, are kept segregated and are determined by merchants individually and independently of other merchants, even though management of accounts associated with the different merchants is performed centrally at central server system 108. Segregation prevents cross-contamination of incentives and awards between merchants, which could otherwise result in some merchants receiving benefits that are out of proportion with the merchandise or services they provide. The sanctity of such separation is maintained by central system 108 and is schematically shown by the individual files 112 dedicated to the individual merchants. These files themselves each contain subfiles 114a, 114b, 114c (collectively 114) associated with individual customers and containing customer account information that is manipulated for example on a transaction basis in the manner described above.

It should be noted that some or all of the customers of Merchant A may also be customers of Merchant B. These overlapping customers need to carry only a single card 106, which is recognized and honored at both Merchant A's and Merchant B's locations by the respective equipment (reader 104a and possibly terminal 102a) of Merchant A and (reader 10b and possibly terminal 102b) of Merchant B. This is an advantage to both the merchants and the customers since the customer only has to carry one card 106 associated with an account with Merchant A and an account with Merchant B, and the customer will therefore be more likely to participate in the loyalty programs of the two merchants.

Because the award systems are merchant-determined and are segregated between merchants, each merchant in the program has the ability to modify the award criteria and other rules and conditions relating to its own rewards program. Remote accessibility to central server system 108 facilitates this and can be gained by the merchants through their processing terminals 102 or by other means, such as other processors, PDAs, cellular or landline telephones, PCs or laptops, and so forth. Any such device can connect to the central server system 108 by way of the network 110 or other networks and effect the desired modifications. Thus a merchant, following known authentication and/or authorization protocols, can gain access to its file 112 and subfiles 114 and to applications associated therewith in central server system 108. The merchant can modify customer files 112 and applications at its discretion pursuant to any agreement with the customer or group of customers, or pursuant to special promotional programs or the like that the merchant is engaged in at a given time. Modification may however be subject to contracts or agreements between merchants in the consortium, or between the manager or service provider in control of the rewards program. Modification may be in the form of addition or deduction of points, alteration of point value, changes to the redemption thresholds, addition, removal or modification of rules or criteria governing redemption, and so on. All of these modifications can be made effective retroactively or proactively.

One advantage of the system as described above is convenience to the customer. While the customer can be rewarded for his/her loyalty by multiple merchants, only a single card 106 or similar machine readable information storage medium need be carried by the customer and presented to the merchants. Customers are often loathe to carry multiple cards each associated with a single merchant, and to fumble through their wallets or handbags for the relevant card to present at each merchant transaction. Further, the value contained in each of multiple merchant-specific cards is smaller than the value of a single card associated with multiple merchants, and a customer may not feel it is worthwhile to carry or be burdened by or keep track of a card that was associated with only one merchant, or a multiplicity of such cards. A single card that is associated with multiple merchants, by comparison, would have a cumulative value that is much higher and would therefore be much more worthwhile to carry. Hence usage of the loyalty program is increased, to the benefit of both customer and merchants.

Another advantage inures to the manager of the rewards program, who has the ability to superimpose its own award system over the existing rewards program under the control of the individual merchants. For example, the manager can establish an overarching program that rewards customers for usage irrespective of at which merchant the usage was made. A customer in this case can receive points or credits for any use of the system. After a threshold number of uses—that is, transactions—at one or a combination of merchants, particularly but not necessarily exclusively merchants that are in the consortium, the manager can provide awards to customers in the form of cash back, gift certificates, merchandise, services, and so forth to the customer to reward and encourage such usage to gain greater acceptance of the card and program.

Cards/information storage media 106 can be branded and be specific to the program managed by the manager or service provider of the system 100, and be marketed as such for use with merchants in the consortium. In an alternative embodiment, existing loyalty programs or components thereof can be linked with the system 100. This is facilitated by the segregated nature of the system 100. In particular, terminals 102 can be configured to recognize information contained in cards currently in use by existing merchants for their own loyalty programs. For example, a grocery store chain such as Von's™ that already has a card-based loyalty program, wherein customers shopping at Von's™ stores receive discounted prices when their cards are swiped through a point-of-sale device such as a card reader, can be seamlessly linked with the system 100 by configuring the readers 104 and terminals 102 of FIG. 1 to recognize information in these preexisting cards and configuring the system to include the new grocery store chain. Configuring may be simply a matter of loading the unique identification data associated with each preexisting Von's™ card into the central server system 108, and ensuring that this data can be properly read by the readers 104 and compared with the loaded and stored data in the server system 108. Specifically, assume that Merchant C was a restaurant different from Von's™ grocery store chain. Card 106′, however, is an existing Von's™ card typically used by customers of Von's™ at Von's™ stores to obtain discounts on their groceries. By configuring reader 104c and processing terminal 102c to read and recognize identification information contained in Von's™ card 106′, customers of Von's™ can become involved the rewards program of Merchant C. This benefits the customers, Merchant C (the restaurant) and Von's™. The benefits for Von's™ include the added value to its current membership card and the increased lifecycle of the card, since the card can now be used not only at Von's™, but also at Merchant C, and other merchants as well who agree to honor the Von's™ card and provide discounts, store credit, cash back, complimentary merchandise or services or any other rewards to Von's™ cardholders. The benefit to the merchants who agree to honor the Von's™ card, such as Merchant C, in turn include gaining access to Von's™ customer base and incentivizing such a pre-existing customer base to patronize their business. Alternatively or in addition, consideration can be exchanged between the merchants and Von's™, for instance a percentage of each transaction conducted using a Von's™ card at a non-Von's™ merchant can be paid back to Von's™ by the merchant, providing Von's™ with residual income which further increase the value of its pre-existing card. Moreover, it should be noted that in the above example a pre-existing loyalty program was linked to the system 100 for use with its loyalty programs. However, it is also possible to link up a set of cards that do not necessarily relate to a loyalty program at all, such that a new program can be established for this set using the system 100. Any card or device bearing identification information can be thus linked to system 100 or incorporated into a program using a system such as system 100. Examples of such cards or devices include gift cards, rewards cards, membership cards (for clubs, etc.), driver's licenses, debit cards, credit cards, identification cards, and so on. Thus in a broad sense it is possible to convert such pre-existing cards into universally-accepted rewards cards for application in a system such as system 100. As discussed above, the information can be stored on such a card or device in the form magnetic strips, smart card chips, optical indicia (bar codes), and so forth.

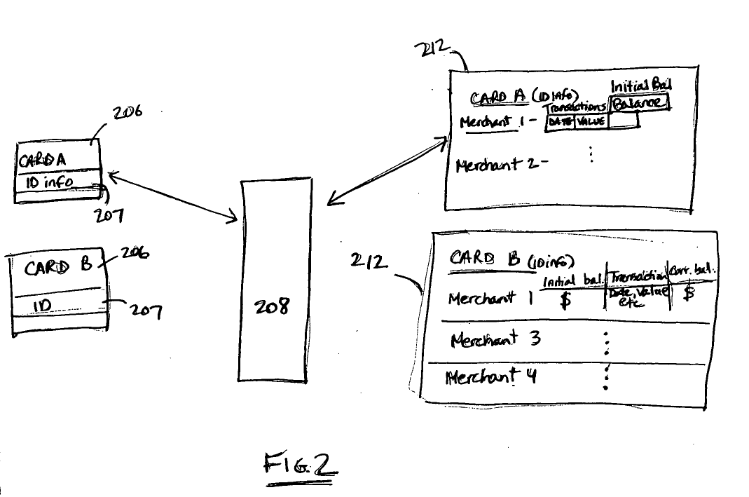

In another embodiment, a single card can be used to store information relating to multiple gift certificates (multiple gift card balances) each associated with a different merchant. Such a card could for example be provided as a holiday gift to a person who had multiple needs. The card could contain a balance for each of the multiple merchants. With reference to FIG. 2, each of a plurality of cards 206 containing identification information 207 in the form of machine readable code stored in a magnetic strip 210 can be associated by server 208 with a file 212. The file tracks, for each merchant, the initial balance and the balance remaining on the card following transactions in which the all or portions of the value of the card are redeemed and accordingly deducted. For example, the card (Card B) could have $50 for a particular department store (Merchant 1), $50 for spa (Merchant 3), and $100 for an entertainment event or events (Merchant 4), such as theater tickets. In other respects, the card would operate as an electronic gift card with multiple balances. The recipient would make a purchase at the department store, and a reader/point-of-sale device similar to (or the same as) reader 104 (FIG. 1) and a processing terminal similar to (or the same as) terminal 102 (FIG. 2) at that department store would recognize the $50 amount and credit same to the customer. The same could occur for the other merchants. In this embodiment as well, each merchant can be provided with access to the server system 208 for manipulation or control of the accounts associated with the gift certificates. For instance, when the gift certificate is first purchased by the donor, the department store merchant can enter at the terminal 102 the initial $50 credit to be recorded in the card 106. The server system 108 is then informed of this transaction and the file 212 associated with that card is credited with $50 assigned to that merchant. The donor can then proceed to a location of the second merchant—that is, the spa—and repeat the procedure for the second and third merchants. Of course, an actual visit to the location of the merchants' terminals 102 and readers 104 is not necessary, and the gift certificates can be activated remotely, particularly by a brokerage specializing in such a business. This can be performed over the Internet, for example, wherein the donor/purchaser would pay for the three-in-one gift certificate online, and the brokerage would create the file 212 in the manner described, associate it with a new card 206, and mail the card to the donor or the donee.

In a further embodiment, a business-to-business trade network can be facilitated by a broker, herein referred to as a barter broker. As is known, there exists a market of barter systems in which different trades and merchants barter services with each other. For example, one trade—a restaurant chain—will barter $10,000 worth of credit for services by other trades. The restaurant chain provides the $10,000 in scrip to the broker, who can in turn give the restaurant $10,000-worth of other services from other merchants. These other services may be $5000-worth of laundry services for its employee uniforms, $3000-worth of advertising from a marketing agency, and $2000-worth of delivery services from a delivery company. Rather than the barter broker mailing three different gift, the barter broker can send out a single card to the restaurant, the single card being associatable with three accounts or balances. The association takes place in a manner similar to that in FIG. 2, wherein in a central server system 208 managed for instance by the barter broker, a file 212 corresponding to the card mailed to the restaurant is established and is populated with entries relating to the three merchants—laundry service, marketing service and delivery service. The file is manipulated in a manner similar to that described above with reference to the gift card example, with transactions being tracked and balances adjusted accordingly as these transactions are conducted using the single, multi-balance card provided to the merchant (restaurant) by the barter broker. Manipulation of the card by the broker can be conducted even after the card is issued to the restaurant. The broker can access the file 212 associated with the restaurant and simply add another merchant to whose services the restaurant can gain access, or increase or decrease balances associated with each merchant, based on an agreement or negotiation between the restaurant, broker, and/or other merchants. Some or all of such agreement and negotiation can take place over the Internet—for example, the restaurant can simply log onto a website of the broker or additional merchant and purchase additional scrip, which the broker then credits to the restaurant's account.

The above are exemplary modes of carrying out the invention and are not intended to be limiting. It will be apparent to those of ordinary skill in the art that modifications thereto can be made without departure from the spirit and scope of the invention as set forth in the following claims.

1. A method of conducting business comprising:
providing at least one customer with a portable device having machine-readable identification information;
establishing a plurality of accounts each corresponding to a merchant and associating the machine readable information with said plurality of accounts;
for at least one transaction with at least one of said plurality of merchants, determining whether said identification information is presented;
if in association with said transaction said identification information is presented, manipulating the account corresponding to the merchant in accordance with the transaction.

2. A method comprising:
distributing to each of one or more customers a portable device having a machine-readable information storage medium for storage of information therein, said information identifying a plurality of accounts associated with said one or more customers, each account corresponding to a different merchant.

3. A method comprising:
authorizing a first loyalty program award by a first merchant based on information stored in a machine-readable information storage medium of a portable device;
authorizing a second loyalty program award by a second merchant based on said information;
adjusting a first account identifiable by said information to account for said first loyalty program award; and
adjusting a second account identifiable by said information to account for said second loyalty program award.

4. The method of claim 3, wherein at least one of said first and second loyalty program awards is credit points.

5. The method of claim 4, wherein said credit points are in proportion to a business transaction between a customer and a merchant.

6. The method of claim 4, wherein said credit points are based on a number of transactions between a customer and a merchant.

7. A method for linking first and second loyalty programs, the method comprising:
configuring a point-of-sale device associated with the second loyalty program to recognize information stored on a portable device associated with the first loyalty program; and
providing a loyalty award based on said recognized information.

8. The method of claim 7, further comprising maintaining segregation between the first and second loyalty programs.

9. The method of claim 7, further comprising independently managing the first and second loyalty programs.

10. The method of claim 7, wherein said independently managing is conducted by a central server system maintaining separate files and applications associated with each of the first and second loyalty programs.

11. The method of claim 7, further comprising manipulating said second loyalty program from a device that is different from said point-of-sale device.

12. The method of claim 11, said manipulating comprising adjusting an award value relative to a transaction characteristic.

13. The method of claim 12, wherein said transaction characteristic is a dollar value of the transaction.

14. The method of claim 12, wherein said transaction characteristic is transaction number.

15. A business method comprising:
writing into a portable device having a machine-readable information storage medium information reflecting an account balance associated with a first merchant; and
writing into said portable device information reflecting an account balance associated with a second merchant.

16. The method of claim 15, wherein writing is conducted from a single device.

17. The method of claim 15, further comprising manipulating said information to reflect a change in an account balance associated with at least one of said first and second merchants.

18. The method of claim 17, wherein said manipulating is effected responsive to a transaction at one of said first and second merchants.

19. A method of administering a barter system comprising:
associating machine-readable identification information contained in a portable device with a plurality of merchants;
establishing a file corresponding to said identification information, said file being associated with a plurality of accounts each corresponding to one of said plurality of merchants; and
assigning a balance to each account.

20. A method of administering a gift certificate program comprising:
associating machine-readable identification information contained in portable device with a plurality of merchants;
establishing a file corresponding to said identification information, said file being associated with a plurality of accounts each corresponding to one of said plurality of merchants; and
assigning a balance to each account.
